(19) United States
(12) Patent Application Publication
(10) Pub. No.: US 2009/0029770 A1
(43) Pub. Date: Jan. 29, 2009

(54) Indicator, Gaming Machine, Game System

(75) Inventor: Hiroyuki NAGANO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/178,112

(22) Filed: Jul. 23, 2008

(30) Foreign Application Priority Data
Jul. 25, 2007 (JP) JP2007-193824

(51) Int. Cl. A63F 13/08; F21S 10/00

(52) U.S. Cl. 463/31; 463/43; 116/222; 116/202

(57) ABSTRACT

A gaming environment is described. An indicator is provided at top of a cabinet of a gaming machine. Also, a light emitting pattern of the indicator is controlled based on an accumulated number of executed games. Also, light-emitting part of the indicator lengthens with an increase in the accumulated number of the executed games.

### CROSS-REFERENCE TO RELATED APPLICATIONS

This application is based upon and claims a priority from the prior Japanese Patent Application No. 2007-193824 filed on Jul. 25, 2007, the entire contents of which are incorporated herein by reference.

### BACKGROUND

1. Field

One or more aspects of the present invention relate to an indicator used in a gaming machine, a gaming machine using the indicator, and a game system using the indicator.

2. Description of Related Art

Conventionally, an indicator is provided at a gaming machine. The indicator indicates different types of information of a condition of the gaming machine such as JACKPOT amount.

A player can understand the JACKPOT amount by looking the indicator. However, the player cannot understand whether or not the JACKPOT will be realized shortly. Also, the player may tend to change gaming machine if the JACKPOT is not realized for a long time. Accordingly, playing time of the gaming machine may be decreased.

### SUMMARY

In view of the foregoing, one or more aspects of the present invention relate to an indicator, a gaming machine, a gaming method thereof, a computer readable medium having computer-executable instructions or the like which provide a gaming environment. An indicator is provided at top of a cabinet of a gaming machine. Also, a light emitting pattern of the indicator is controlled based on an accumulated number of executed games. Also, light-emitting part of light emitters lengthens with an increase in the accumulated number of the executed games.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a perspective view showing an outer appearance of a slot machine according to one or more aspects of the invention.

FIG. 2 is a block diagram showing an internal configuration of the slot machine according to one or more aspects of the invention.

FIG. 3 is a block diagram showing an internal configuration of a sub-control board of the slot machine according to one or more aspects of the invention.

FIG. 4 is a view showing light emitting patterns of an indicator according to one or more aspects of the invention.

FIG. 5 is a flowchart of a main control process according to one or more aspects of the invention.

FIG. 6 is a flowchart of a main game process according to one or more aspects of the invention.

FIG. 7 is a view showing a condition where each of light emitters has number according to one or more aspects of the invention.

FIG. 8 is a view showing a value table according to one or more aspects of the invention.

FIG. 9 is a view showing a relationship between a light emitting pattern and accumulated number of executed games according to one or more aspects of the invention.

FIG. 10 is a view showing a relationship between a light emitting pattern and accumulated number of executed games according to one or more aspects of the invention.

FIG. 11 is a perspective view showing an outer appearance of the indicator and slot machines according to one or more aspects of the invention.

FIG. 12 is a view showing a condition where each of light emitters has number according to one or more aspects of the invention.

FIG. 13 is a view showing light emitting patterns of the indicator according to one or more aspects of the invention.

FIG. 14 is a sectional view of the indicator according to one or more aspects of the invention.

FIG. 15 is a view showing a schematic circuit diagram of the indicator according to one or more aspects of the invention.

FIG. 16 is a view showing a relationship between accumulated number of executed games and voltage level according to one or more aspects of the invention.

FIG. 17 is a flowchart of a main control process program according to one or more aspects of the invention.

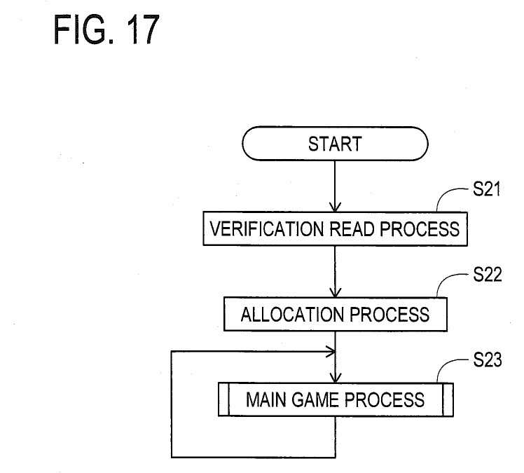

FIG. 18 is a view showing a value table according to one or more aspects of the invention.

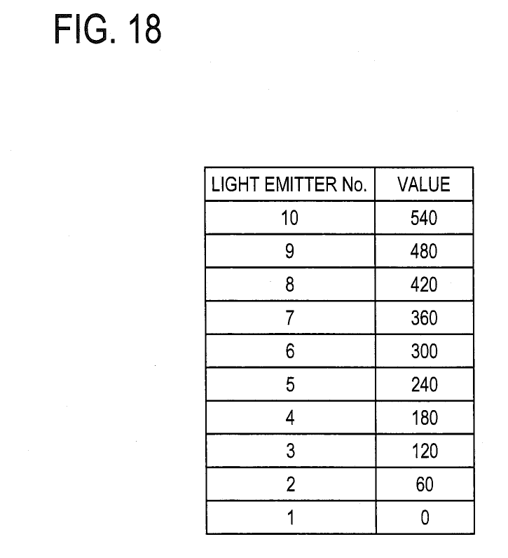

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

An indicator, a gaming machine, and a game system according to one or more aspects of the invention will be described in detail with reference to the drawings based on an embodiment embodying one or more aspects of the invention as a slot machine or the like. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

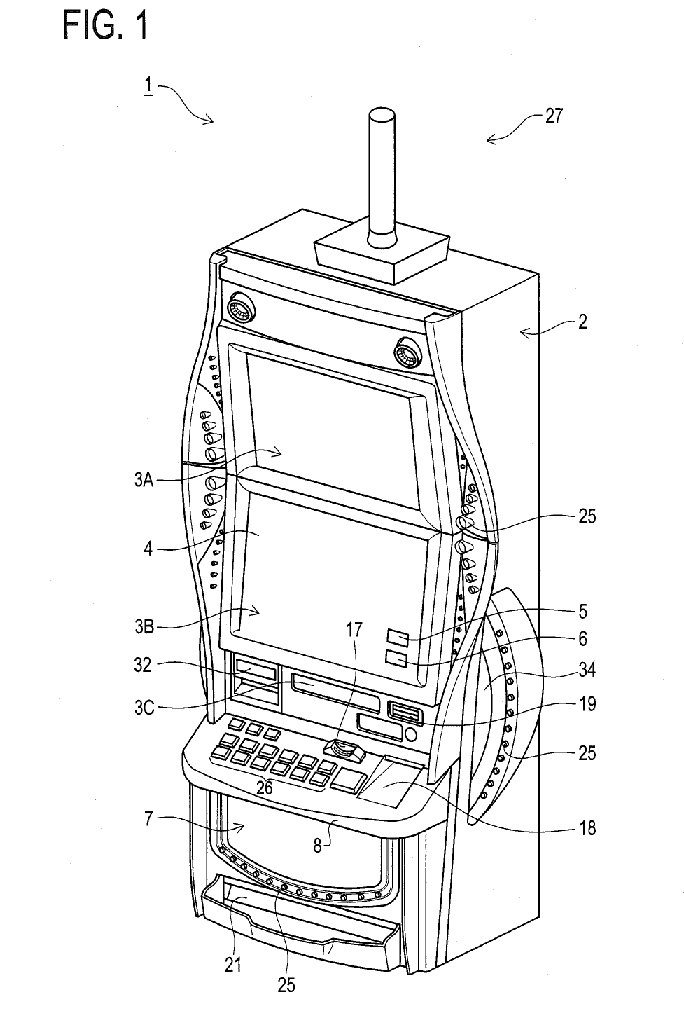

In a slot machine related to a first embodiment embodying one or more aspects of invention, as shown in FIG. 1, an indicator 27 is provided at top of a cabinet 2 of a slot machine 1. Also, a light emitting pattern of the indicator 27 is controlled based on an accumulated number of executed games. Also, light-emitting part of the indicator 27 lengthens with an increase in the accumulated number of the executed games.

### First Embodiment

A schematic configuration of a slot machine 1 according to the first embodiment will be described with reference to FIG. 1. FIG. 1 is a perspective view showing an outer appearance of the slot machine 1 and the indicator 27 according to the first embodiment.

The slot machine 1 according to the first embodiment is an upright-type slot machine positioned in a gaming arcade such as a casino or the like. Here, the outer shape of the slot machine 1 shown in FIG. 1 is given as merely one example, and the present invention is not limited to this outer shape.

The slot machine 1 has a cabinet 2. The cabinet 2 is a housing portion that houses electrical or mechanical components which are used in execution of a predetermined game aspect.

An upper display portion 3A, a variably display portion 3B, and an under display portion 3C are arranged in front of the slot machine 1 so as to display different type of game information. The upper display portion 3A is arranged upper side of the cabinet 2, the variably display portion 3B is arranged middle side of the cabinet 2, and the under display portion 3C is arranged lower side of the cabinet 2.

The upper display portion 3A is constructed form a liquid crystal panel. Effects images, payout tables of games, game rules, or the like are displayed on the upper display portion 3A.

The variably display portion 3B is constructed form a liquid crystal panel. The variably display portion 3B has plural reel display portions. On each of the reel display portions, symbol rows are variably displayed and stopped displayed.

A touch panel 4 is provided at a front face of the variably display portion 3B. The player can operate the touch panel 4 to input various types of commands. Also, a payout number display portion 5 and a credit number display portion 6 are arranged on the variably display portion 3B. The displayed position of the payout number display portion 5 and the credit number display portion 6 are variable. For example, these are displayed on lower right side portion of the variably display portion 3B. Also, a bet number display portion may be arranged so as to display bet number. The payout number which will be provided to the player (that is, payout number to be provided when specific symbols are displayed with the predetermined number in a base game and accumulated payout number obtained in free games) are displayed on the payout number display portion 5. The credit number which the player currently owns is displayed on the credit number display portion 6.

The under display portion 3C is constructed from a liquid crystal panel. Number of points stored in a card and/or number of game points are displayed on the under display portion 3C. Also, when the card is not inserted and/or error of reading the card occurs, message which indicates that is displayed.

Also, a card reader 19 is arranged around the under display portion 3C. The card reader 19 can read information from the card in which the player owns.

The upper display portion 3A, the variably display portion 3B, and the under display portion 3C are constructed from the liquid display for example, however, one or more aspects of the invention is not so limited. That is, each of the variably display portion can be CRT displays, plasma displays, LED displays, or other known display devices.

A lower back panel 7 is arranged lower side of the under display portion 3C and is constructed from plastic panel. Character pictures related to the gaming machine, name of the gaming machine, and the like are displayed and the lower back panel is lit by the backlight. The lower back panel 7 can be CRT displays, plasma displays, LED displays, or other known display devices.

Also, the variably display portion 3B can be hybrid type slot machine which is made up of mechanical reels and transparent liquid crystal display device arranged in front of the mechanical reels. In this case, symbols displayed on the mechanical reels are visible perceived via the transparent liquid crystal display device. Also, it is preferable that display windows whose number is the same as the number of the mechanical reels is arranged on the transparent liquid crystal display device and it is constructed so that symbols displayed on the mechanical reels are visible perceived via the window displays. Here, in following explanation, slot machines using video reels are mainly described, however, naturally, the present invention is can be applied to slot machines using mechanical reels within applicable limits.

An operation table 8 formed by projecting to proximal side is provided at the bottom of the variably display portion 3B. Various operation buttons 26, such as an exchange button, a payout button, a help button, a bet button, and start button or the like, are arranged on the operation table 8. An arrangement of these buttons is variable. Also, a part of the buttons can be omitted, and new button can be added or replaced, as needed. Also, a coin insertion slot 17 and a bill verifier 18 are arranged on the operation table 8.

Also, a coin payout opening and a coin receiving portion 21 is formed on lower portion of the cabinet 2. The coin payout opening is a portion where coins are paid out based on inputs of the exchange button or the payout button. And, the coin receiving portion 21 is a portion where the coins which are paid out from the coin payout opening are received. A coin detection portion made up of sensor or the like is arranged inside the coin payout opening. The coin detection portion detects the number of coins which are paid out from the payout opening.

Light emitting portions 25, which lights up in a predetermined lighting pattern when winning combination is realized and during the free game, are arranged around the cabinet 2 of the slot machine 1. Loudspeakers 34 which outputs audio are arranged at side of the cabinet 2. Here, arranged positions of the light emitting portion 25 and the loudspeaker 34 are variable.

The indicator 27 is provided at top of the cabinet 2 of the slot machine 1. The indicator 27 has cylindrical shape. The indicator 27 has plural light emitters. Also, the shape of the indicator 27 is variable.

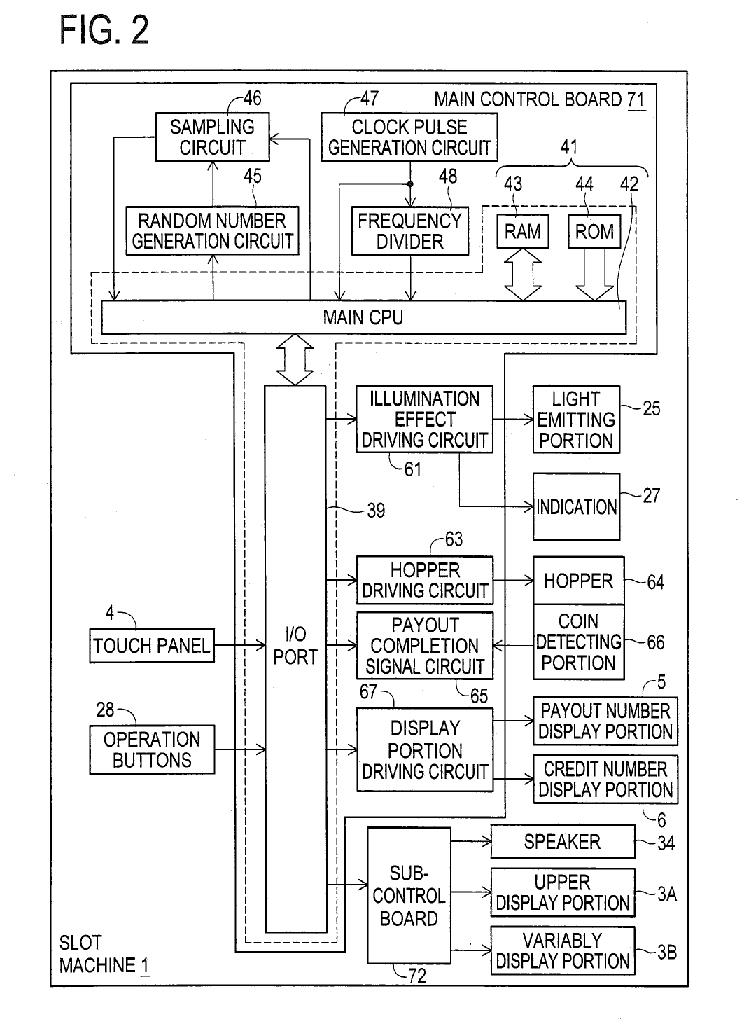

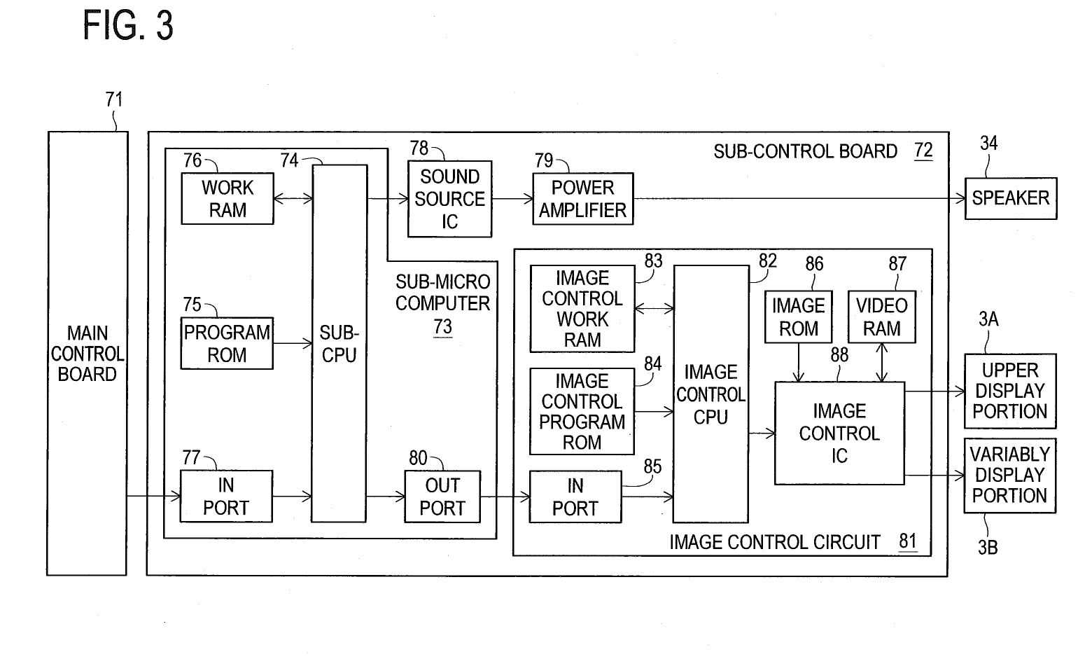

Next, the internal configuration of the above-mentioned slot machine 1 will be described with reference to FIG. 2 and FIG. 3. FIG. 2 is a block diagram showing an internal configuration of the entire slot machine 1. FIG. 3 is a block diagram showing an internal configuration of a sub-control board of the slot machine. As shown in FIG. 2, the slot machine 1 has a plurality of constituent elements arranged around a main control board 71 including a controller 41 that executes control programs that will be described later. The main control board 71 has a controller 41, a random number generation circuit 45, a sampling circuit 46, a clock pulse generation circuit 47, a divider 48, an illumination effect driving circuit 61, a hopper driving circuit 63, a payout completion signal circuit 65 and a display portion driving circuit 67.

The controller 41 has a main CPU 42, a RAM 43 and a ROM 44. The main CPU 42 operates in accordance with the programs stored in the ROM 44 and performs signal input and output with respect to the other constituent elements through an I/O port 49. Specifically, the main CPU 42 controls the operation of the entire slot machine 1. The RAM 43 stores data and programs to be used when the main CPU 42 is operating. For instance, the RAM 43 temporarily retains the random number values which have been sampled by the sampling circuit 46 after the game has started. The RAM 43 stores code numbers corresponding to the respective reels. The ROM 44 stores various types of programs that will be executed by the main CPU 42, as well as permanent data.

More particularly, the programs stored in the ROM 44 include game programs and game system programs (hereinafter referred to as game programs or the like). Further, the game programs include lottery programs as will be described later.

The lottery programs are used to determine the code numbers corresponding to symbols to be displayed on center positions of each reel display portion of the variably display portion 3B.

This lottery program includes symbol weighing data. The symbol weighing data shows correspondence relationships between the respective code numbers and one or a plurality of random number values within a predetermined number value range (for instance 0 through 255). The probability of lottery with respect to each symbol is set by associating one or a plurality of random number values to one code number. The random number values are drawn by lottery and symbols which have been finally identified from the random number values are re-positioned on the variably display portion 3B. The lottery program for determining the symbols to be positioned may also employ weighing data in which the predetermined random number range is associated to the symbol combination. In this case, determined winning combination is displayed on the variably display portion 3B.

The random number generation circuit 45 operates in accordance with the commands from the main CPU 42 and generates random numbers within a predetermined range. The sampling circuit 46 selects, by lottery, an arbitrary random number from the random numbers generated by the random number generation circuit 45 in response to a command from the main CPU 42. At the same time, the sampling circuit 46 inputs the random number thus selected to the main CPU 42. The clock pulse generation circuit 47 generates a reference clock for causing the main CPU 42 to operate. The divider 48 inputs a signal obtained by dividing the reference clock by a constant frequency to the main CPU 42.

The main control board 71 is connected to the touch panel 4. As described above, the touch panel 4 is arranged at a front face of the variably display portion 3B and is adapted to identify a coordinate position of the portion that was touched by the player. Specifically, the touch panel 4 can discriminate the portion that the player has touched, and in what direction the touched portion was moved based on the coordinate position information that was thus identified. A signal in accordance with the above discrimination is then inputted to the main CPU 42 through the I/O port 49.

The main control board 71 is connected to the operation button 26 (the start button and the like, as mentioned above) and a signal in accordance with a depression operation of these buttons is inputted to the main CPU 42 through the I/O port 49.

The illumination effect driving circuit 61 outputs an effect signal for causing the light emitting portions 25 as mentioned above to perform illumination effects. Also, the illumination effect driving circuit 61 controls light emitting pattern of the indicator 27. The light emitting patterns will be described later.

The hopper driving circuit 63 drives the hopper 64 under the control of the main CPU 42. As a result, the hopper 64 carries out an operation to payout coins to the coin payout opening. The payout completion signal circuit 65 receives coin amount value data from the coin detecting portion 24 to which it is connected. Then, when the received coin amount value has reached the set coin amount value, the payout completion signal circuit 65 inputs a signal that notifies completion of coin payout to the main CPU 42. The coin detecting portion 24 detects the number of coins that were paid out by the hopper 64 and then inputs coin amount value data showing the amount of coins that was detected to the payout completion signal circuit 65. The display portion driving circuit 67 controls the display operation of the respective display portions including the payout number display portion 5, the credit number display portion 6, and the like.

The main control board 71 is connected to the sub-control board 72. As shown in FIG. 3, the sub-control board 72 carries out display control of each of the display portion and output control of the audio outputted by the loudspeaker 34, based on the commands received from the main control board 71. This sub-control board 72 is constituted on a separate circuit board from the circuit board that constitutes the main control board 71. The sub-control board 72 has a micro computer (hereinafter referred to as “sub-micro computer”) 73 which is provided as a main constituting element. Then, the sub-control board 72 has a sound source IC 78, a power amplifier 79, and an image control circuit 81. The sound source IC 78 controls the audio output from the loudspeaker 34. The power amplifier 79 functions as an amplifier. The image control circuit 81 operates as a display control section for the upper display portion 3A and the variably display portion 3B.

The sub-micro computer 73 has a sub-CPU 74, a program ROM 75, a work RAM 76 and I/O ports 77 and 80. The sub-CPU 74 carries out a control operation in accordance with a control command transmitted from the main control board 71. Although the sub-control board 72 does not have a clock pulse generation circuit, a divider, a random number generation circuit and a sampling circuit, it is constituted so as to execute sampling of random numbers based on an operation program of the sub-CPU 74. The program ROM 75 stores a control program to be executed by the sub-CPU 74. The work RAM 76 is constituted as a temporary memory to be used by the sub CPU 74 in executing the control program.

The image control circuit 81 has an image control CPU 82, an image control work RAM 83, an image control program ROM 84, an image ROM 86, a video RAM 87 and an image control IC 88. The image control CPU 82 determines the image to be displayed on the upper display portion 3A and the variably display portion 3B based on the parameters set in the sub-micro computer 73 and the image control programs stored in the image control program ROM 84.

The image control program ROM 84 stores an image control program and various types of selection tables relating to display on the upper display portion 3A and the variably display portion 3B. The image control work RAM 83 functions as a temporary memory to be used in execution of the image control program in the image control CPU 82. The image control IC 88 forms an image in accordance with the contents determined by the image control CPU 82 and then outputs the image thus formed to the upper display portion 3A and the variably display portion 3B.

The image ROM 86 stores dot data for forming an image. The video RAM 87 functions as a temporary memory to be used by the image control IC 88 in forming an image.

Here, the internal construction of the slot machine 1 as mentioned above is merely one example and one or more aspects of the invention is not so limited. For example, memory card and/or PLD (Programmable Logic Device) may be detachably from the slot machine 1 and necessary information may be read from the memory card and/or the PLD.

The slot machine 1 of the first embodiment employs coins, bills or electronic value information (credit) corresponding to these, as gaming values. The gaming values applicable to the present invention are not limited to those described above, and can include, for instance, medals, tokens, electronic money and tickets.

Next, concrete configuration of the indicator 27 will be described. Hereinafter, the indicator 27 having the cylindrical shape will be described. However, the invention is not so limited to the shape. Plural light emitters (LEDs) are arranged inside the indicator 27. Light emitting of each LED is independently controlled. Also, each of the light emitters can be constructed from plural LEDs. Also, each of the light emitters can be constructed from other than LED.

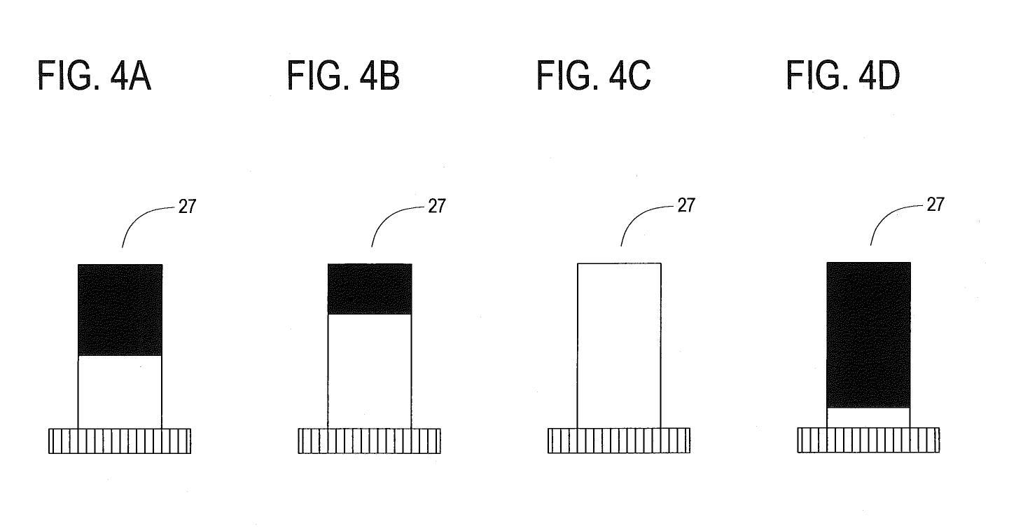

FIG. 4 is a view showing the indicator 27 from lateral direction. As shown in FIG. 4, a part of the light emitters can light up. Length of light-emitting part corresponds to the accumulated number of executed games since the predetermined award was provided. That is, in FIG. 4, the accumulated number of executed games since the predetermined award was provided is larger in the following order, (C)→(B)→(A)→(D).

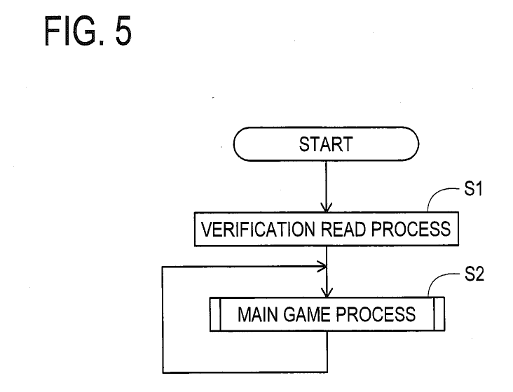

Next, a main control program executed in the slot machine 1 of the embodiment will be described in detail with reference to drawings. FIG. 5 is a flowchart of the main control process.

First, when the power switch is turned on (upon power on), the main control board 71 and the sub-control board 72 are activated, and the controller 41 executes an initial setting process at step (hereinafter referred to as S) 1. In the initial setting process, the main CPU 42 executes the BIOS stored in the ROM 44 and expands the compressed data incorporated in the BIOS in the RAM 43. By executing the BIOS that was expanded in the RAM 43, the main CPU 42 carries out a diagnosis and initialization of the different types of peripheral devices. Further, the main CPU 42 writes the game programs and the like from the ROM 44 into the RAM 43 to acquire payout rate setting data and country identification information. While executing the initial setting process, the main CPU 42 also carries out an authentication process with respect to each program.

Then, at step S2, the main CPU 42 sequentially reads the game programs and the like from the RAM 43 and executes these programs to carry out a main game process. The slot machine 1 according to the embodiment carries out the game by executing this main game process. The main game process is repeatedly executed while power is supplied to the slot machine 1.

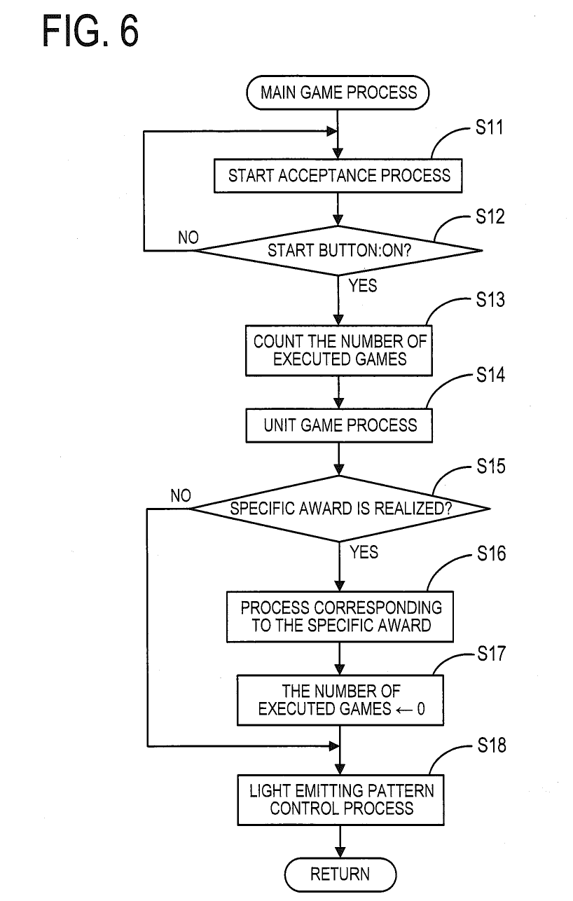

Next, a sub-process of the main game process at the above-described step S2 will be described based on FIG. 6. FIG. 6 is a flowchart of the main game process program to be executed in the slot machine 1 according to the embodiment. The programs shown in the flowcharts of the main game process are stored in the ROM 44 and RAM 43 provided in the slot machine 1 and are executed in the main CPU 42.

The main CPU 42 first executes a start acceptance process at S11. In the star acceptance process, the player inserts coins and places a bet using the BET button from amongst the operation buttons 26.

At S12, the main CPU 42 determines whether or not the start button from amongst the operation buttons 26 has been depressed. This determination is carried out based on the signal inputted to the main CPU 42 in response to depression of the start button. Here, if the start button has not been depressed (S12:NO), the flow returns to the start acceptance process (S11). As a result, the player can carry out an operation to correct, etc. the bet amount. Alternatively, if the start button has been depressed (S12:YES), the main CPU 42 subtracts the bet amount set based on the above-described bet operation from the credit amount that the player currently possesses and at the same time stores the result as bet information in the RAM 43. After that, the procedure will be shifted to S13.

At S13, the accumulated number of the executed games since a predetermined award is provided is counted. The accumulated number is stored in the RAM 43.

At S14, a unit game process is executed. Here, the unit game means a sequence of process where each of the reels starts to variably display and then the entire reels are stopped displayed

At S15, it is determined whether or not the predetermined award is realized. Here, the predetermined award may a big bonus, JACKPOT, or the like.

At S16, a process corresponding to the predetermined award is executed.

At S17, the accumulated number is reset. That is, the accumulated number is set to “0”, for example.

At S18, light emitting pattern of the indicator 27 is controlled based on the accumulated number of executed games.

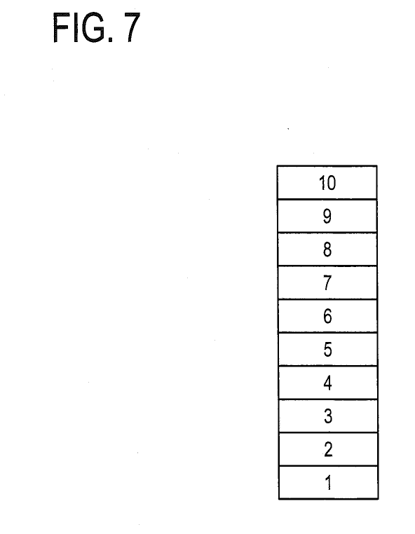

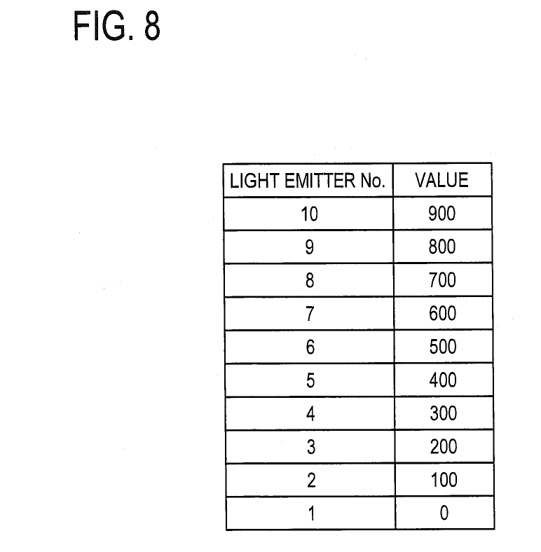

Next, light emitting pattern control process will be described. This process is executed using the accumulated number of executed games stored in the RAM 43. Hereinafter, one example in which the indicator 27 has ten of the light emitters shown in FIG. 7 will be described. As shown in FIG. 7, each of the light emitters has number, from the bottom. Also, the slot machine 1 has a table in which each of the number corresponds to value, as shown in FIG. 8. Here, the value corresponding to the number is variable.

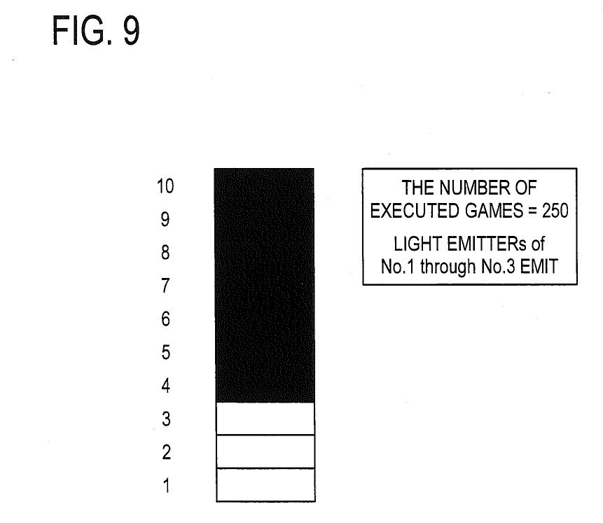

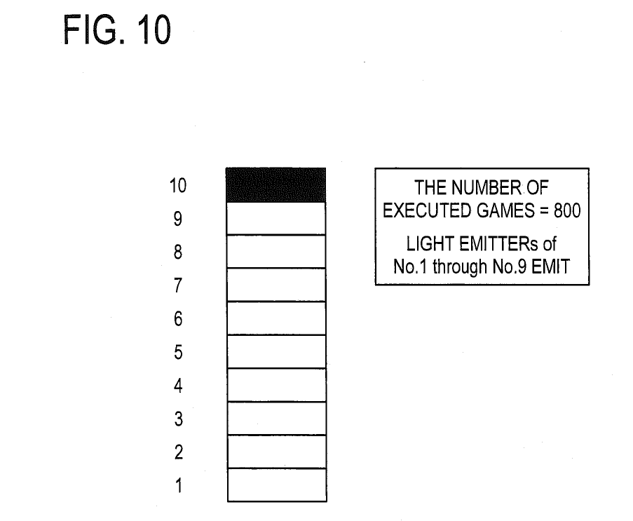

If the value corresponding to the light emitter is equal to or less than the accumulated number of executed games, the light emitter will light up, by using the table. In a case where the accumulated number of executed games is “250”, since “200”, “100”, and “0” are less than “250”, the light emitters 1 through 3 corresponding to these numbers light up. That is, three of the light emitters from the bottom light up (see FIG. 9). Also, in a case where the accumulated number of executed games is “800”, the light emitters 1 through 9 light up. That is, nine of the light emitters from the bottom light up (see FIG. 10).

Since lottery for the predetermined award is conducted every unit game, realizability of the predetermined award does not change even though “lose” continues. However, the player may think that gaming machine in which “lose” more continue may realize the predetermined award next game. Accordingly, the light emitting pattern can indicate sensuously to the player.

### Second Embodiment

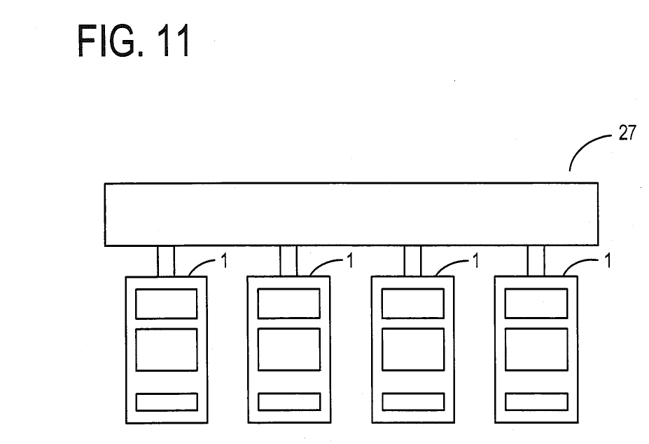

Next, an indicator embodying one or more aspects of the invention will be described with reference to FIG. 11. As shown in FIG. 11, the indicator 27 is arranged on top of four of the slot machines 1. In this case, one of the illumination effect driving circuits 61 of the slot machines 1 can control the light emitting pattern of the indicator 27. Also, a server (not shown) can control the light emitting pattern of the indicator 27.

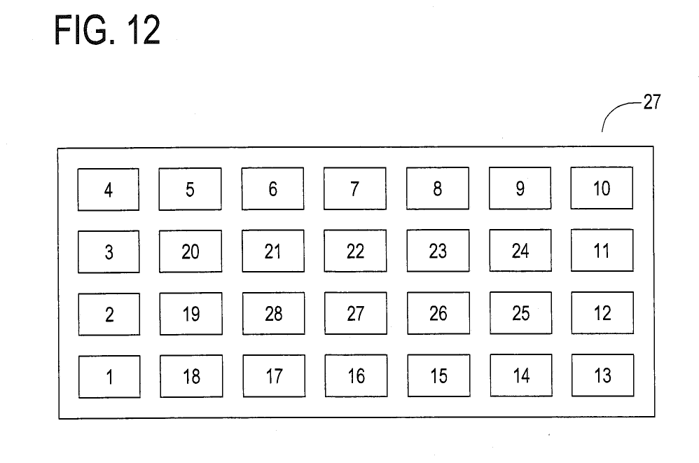

FIG. 12 shows light emitters arranged inside the indicator 27. As shown in FIG. 12, plural light emitters are arranged in a matrix shape, and each of the light emitters is numbered in a spiral manner.

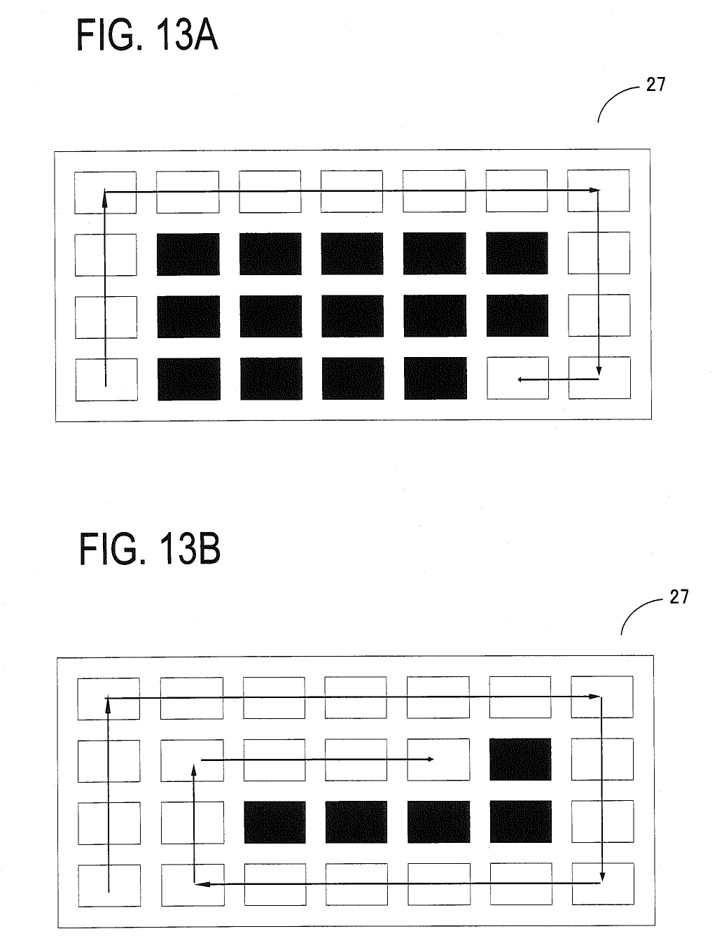

Also, each of the light emitter has value, like the table shown in FIG. 8. Accordingly, as shown in FIG. 13, light-emitting part lengthens with an increase in the accumulated number of executed games (FIG. 13A→FIG. 13B).

### (Internal Configuration of Indicator)

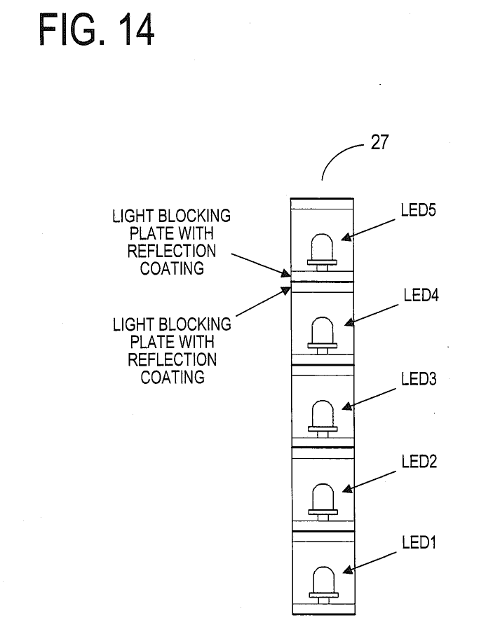

Internal configuration of the indicator will be described. Hereinafter, one example in which the indicator 27 has five of the light emitters (LEDs) will be described. In one or more aspects of the invention, the number of the light emitters is variable. FIG. 14 is a sectional view of the indicator 27. As shown in FIG. 14, the indicator 27 is separated into five compartments. Each of LEDs is arranged on basal plane of each compartment. Also, light blocking plates with reflection coating are arranged on ceiling plane and basal plane of each compartment. Also, each of LEDs may be arranged on ceiling plane of each compartment.

Accordingly, since the light from the LED reflect inside the compartment, the compartment, which the LED lights, will light brightly. Also, since the light blocking plates are arranged, the light does not leak into other compartments. Also, lateral side of the indicator 27 can be made of material which is permeable and translucent.

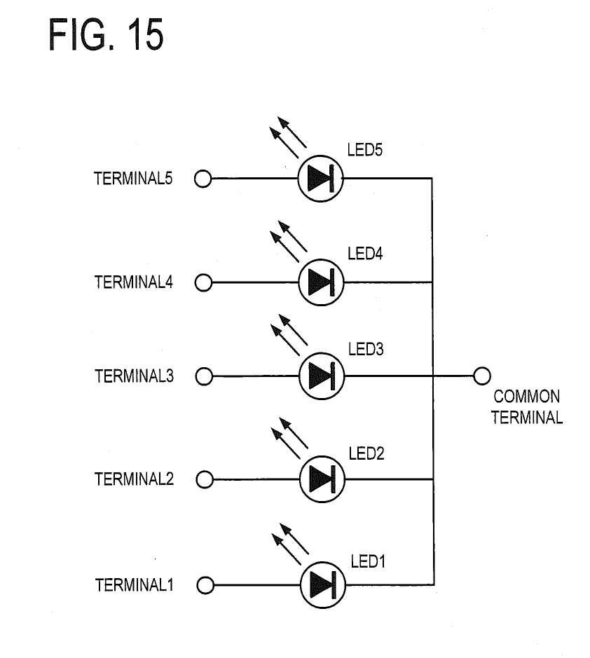

FIG. 15 shows a schematic circuit diagram of the indicator shown in FIG. 14. In FIG. 15, cathode-common in which cathode terminals is shown, however, the indicator can has an anode-common. In FIG. 15, if each of voltages of each terminal 1 through 5 is “H level”, each of the LEDs 1 through 5 will light up.

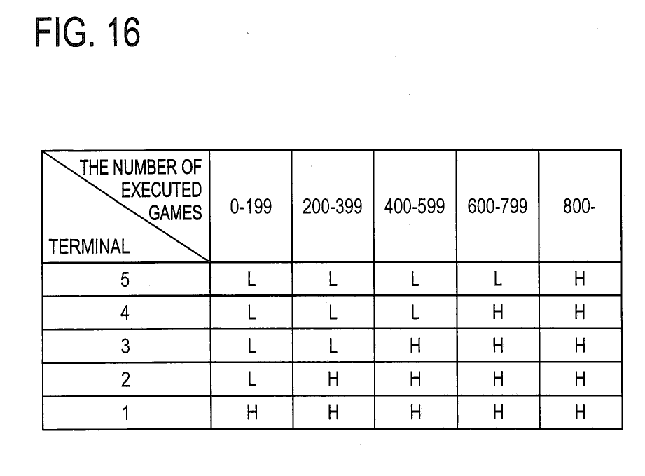

Accordingly, the light emitting pattern of the indicator can be controlled by controlling the voltage of each terminal. FIG. 16 shows a table indicating a relationship between the accumulated number of executed games and voltage. For example, if the accumulated number of executed games is “350”, since voltages of the terminal 1 and the terminal 2 is “H level”, two of the LEDs from the bottom light up.

Also, in the second embodiment, surface of the indicator can be made of material which is permeable and translucent, and light blocking plates with reflection coating are arranged on ceiling plane, side and basal plane of each compartment.

### (Setting Method of Value Table)

It is preferable that the indicator is used in various gaming machines. Various gaming machine have different realizability of the predetermined award (theoretical interval value of the predetermined award). Therefore, it is necessary to set the value table shown in FIG. 8 based on the realizability of the predetermined award. For example, if same value table is used in both a gaming machine which the theoretical interval is “800” and a gaming machine which the theoretical interval is “3000”, it cannot indicate adequately to the player.

For example, in a case where the value table shown in FIG. 8 is used in the gaming machine which the theoretical interval is “3000”, if the accumulated number of executed games is “800”, nine of the light emitters from the bottom light up. In this case, the player may anticipate that the predetermined award will be realized shortly.

As a result, it is necessary to set the value table based on the theoretical interval of the gaming machine. Also, it may be necessary that the value table is set by the slot machine 1 but by hall staff.

A main control process considering the above point will be described with reference FIG. 14. FIG. 14 shows a flowchart of the main control process. Since processes of S21 and S23 are same as the processes of S1 and S2 of the first embodiment (see FIG. 5), a value allocation process will be described.

At first, theoretical interval value of the predetermined award (as “MAX”) is obtained from a predetermined storage (for example, the RAM 43). Also, some slot machines may have the theoretical interval value of the predetermined award but probability of the predetermined award. In this case, the probability of the predetermined award is obtained and then an inverse number of the probability is calculated, as the theoretical interval value.

Next, the number of the light emitters of the indicator 27 is obtained, as “N”.

And then, value “d” of the light emitter corresponding to “n” is calculated by following formula.

d=(n−1)×MAX/N

In a case where the theoretical interval is “600” and the number of light emitters is “10”, each of values is set as shown in FIG. 15.

Above process is applicable in the indicator 27 arranged on plural gaming machines of the second embodiment.

Here, each of the flowcharts as mentioned above is a merely example, and one or more aspects invention may be implemented by other flowchart(s) which can obtain the same result of above processes.

Here, the present invention is not limited to above embodiments and various changes and modifications can be done within the scope of the present invention certainly. For example, a gaming machine, which larger outcome amount can be obtained, may have an indicator having larger circular cylinder. Also, a gaming machine, which has larger theoretical interval, may have an indicator having larger circular cylinder.

Also, one or more aspects of the invention can be implemented as a playing method to execute above processes. Further, one ore more aspects of the invention can be implemented as a program to execute above processes in one or more computers, and a tangible medium in which the program is stored.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A indicator comprising:
plural light emitters,
wherein the indicator is arranged on a gaming machine, and
a light-emitting part of the indicator lengthens with an increase in the number of executed games since a predetermined award is provided.

2. The indicator according to claim 1, wherein
the light emitters line up longitudinally,
a number of the light emitters which light up is determined based on the number of the executed games, and
N of the light emitters from bottom light up, the N being the determined number.

3. The indicator according to claim 1, wherein each of the light emitters is divided by a light blocking plane with reflection coating.

4. A gaming machine comprising:
an indicator having plural light emitters,
a memory stores a number of executed games since a predetermined award is provided, and
a processor programmed to:
(a) display a result of a game,
(b) provide a predetermined award if the displayed result is a predetermined result,
(c) count the number of executed games,
(d) store the counted number in the memory, and
(e) control a light emitting pattern of the light emitters based on the stored number.

5. The gaming machine according to claim 4, wherein each of the light emitters is divided by a light blocking plane with reflection coating.

6. A gaming machine comprising:
an indicator having N of light emitters, and
a processor programmed to:
(a) obtain a probability of an occurrence of a predetermined award,
(b) calculate a theoretical interval value of occurrence of the predetermined award based on the probability,
(c) allot one different number to each of the light emitters,
(d) obtain a number of executed games since the predetermined award is provided, and
(e) light the light emitter having a predetermined value, the predetermined value being equal to or less than the number of the executed games.

7. The gaming machine according to claim 6, wherein
the light emitters line up longitudinally, and
a smaller value is assigned to the light emitter arranged lower level.

8. A game system comprising:
an indicator having N of light emitters,
plural gaming machines, and
a processor programmed to:
(a) obtain a probability of occurrence of a predetermined award,
(b) calculate a theoretical interval value of occurrence of the predetermined award based on the probability,
(c) allot one different number to each of the light emitters,
(d) obtain a summation of a number of games executed in each of the gaming machines, and
(e) light the light emitter having a predetermined value, the predetermined value being equal to or less than the summation.

9. The game system according to claim 8, wherein
the indicator is arranged on the gaming machines,
the light emitters are arranged in a matrix shape, and
the light emitters are numbered in a spiral manner from outside.
